(19) United States
(12) Patent Application Publication
(10) Pub. No.: US 2024/0143257 A1
(43) Pub. Date: May 2, 2024

(54) HYBRID STRUCTURE DISPLAYS

(71) Applicant: Hewlett-Packard Development Company, L.P., Spring, TX (US)

(72) Inventors: Alexander Morgan Williams, Spring, TX (US); Anthony Nicholas Kaplanis, Spring, TX (US); Syed S. Azam, Tomball, TX (US)

(21) Appl. No.: 17/975,354

(22) Filed: Oct. 27, 2022

(51) Int. Cl. G06F 3/14; G06F 3/041; G06F 21/32

(52) U.S. Cl. CPC G06F 3/14; G06F 3/041; G06F 21/32

(57) ABSTRACT

In some examples, an apparatus includes a hybrid structure display including a display component and an environmental structure. In some examples, the apparatus includes a sensor to detect positional information corresponding to a user. In some examples, the apparatus may include a processor to determine a subset region of the hybrid structure display based on the positional information. In some examples, the processor is to cause the hybrid structure display to display a channel of content in the subset region.

### BACKGROUND

Electronic technology has advanced to become virtually ubiquitous in society and has been used for many activities in society. For example, electronic devices are used to perform a variety of tasks, including work activities, communication, research, and entertainment. For instance, computers may be used to communicate over the Internet, write documents, perform mathematical calculations, listen to music, and watch video.

### BRIEF DESCRIPTION OF THE DRAWINGS

FIG. 1 is a diagram illustrating an example of a hybrid structure display that may be utilized in accordance with some examples of the techniques described herein;

FIG. 2 is a block diagram illustrating an example of an apparatus including a hybrid structure display;

FIG. 3 is a block diagram illustrating an example of an electronic device that may be used to operate a hybrid structure display;

FIG. 4 is a flow diagram illustrating an example of a method for displaying content of a hybrid structure display;

FIG. 5 is a block diagram illustrating an example of a computer-readable medium for controlling a hybrid structure display; and

FIG. 6 is a diagram illustrating an example of a hybrid structure display with a first subset region and a second subset region.

### DETAILED DESCRIPTION

Some examples of the techniques described herein provide approaches to tailor content to a user(s) of a hybrid structure display. A hybrid structure display is a display device that includes a display component (e.g., display panel) and an environmental structure (e.g., an architectural structure and/or a furniture structure). For instance, a transparent wall may include an integrated display panel. Some examples of a hybrid structure display may be relatively large (e.g., a wall approximately 12.5 feet in width and 7 feet in height (12.5′×7′), a table top approximately 9 feet in length and 5 feet in width (9′×5′), etc.).

Throughout the drawings, similar reference numbers may designate similar or identical elements. When an element is referred to without a reference number, this may refer to the element generally, with or without limitation to any particular drawing or figure. In some examples, the drawings are not to scale and the size of some parts may be exaggerated to more clearly illustrate the example shown. Moreover, the drawings provide examples in accordance with the description. However, the description is not limited to the examples provided in the drawings.

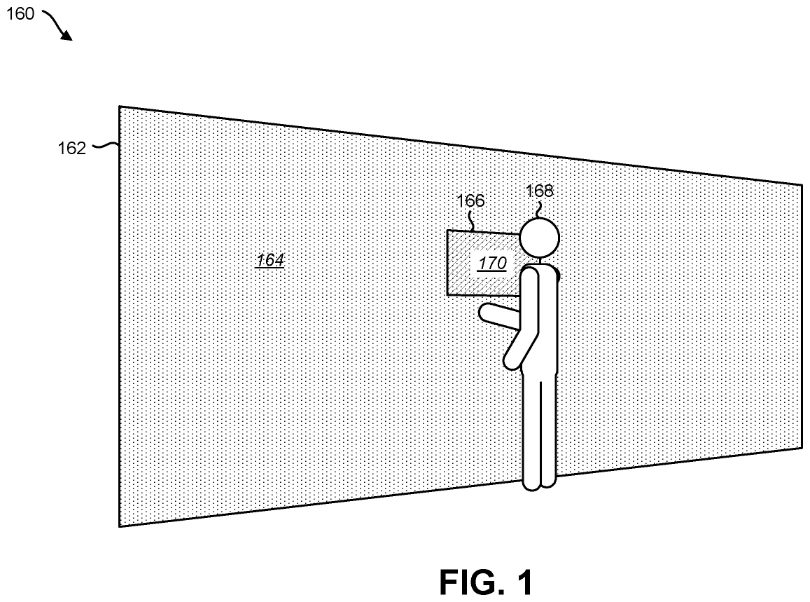

FIG. 1 is a diagram illustrating an example of a hybrid structure display 160 that may be utilized in accordance with some examples of the techniques described herein. The hybrid structure display 160 may include an environmental structure 162. An environmental structure is a structure built to provide human surroundings. Examples of an environmental structure may include an architectural structure and/or furniture. An architectural structure is a building or a portion of a building. An example of an architectural structure may include a wall, door, floor, window, ceiling, etc. In some examples, an architectural structure may be a fixture and/or may be statically located (e.g., a wall in an airport, a countertop in a kitchen, a ceiling, etc.). In some examples, an architectural structure may be a component of a place of occupancy (e.g., floor of a cruise ship, a door in a hotel, etc.). Some examples of furniture may include a table, a desk, a chair, etc. In the example of FIG. 1, the environmental structure 162 is a wall.

The hybrid structure display 160 may include a display component 164. A display component is a component capable of producing an image. Examples of a display component may include a display panel (e.g., liquid crystal display (LED) panel, organic light-emitting diode (OLED) panel, etc.), a light array, digital sign, etc. In some examples, the term “hybrid structure display” may exclude a television(s) (e.g., wall-mounted television(s)), monitor(s), mobile device screen(s), appliance(s), etc.

In the example of FIG. 1, a user 168 may walk up to the hybrid structure display 160 and define a subset region 166 to allow viewing of a channel of content 170 (e.g., personalized content). For instance, some of the techniques described herein may provide determination of a subset region in a location for ease of viewing (e.g., at a user's level) and/or content personalization. In some examples, a user may touch a point on the hybrid structure display 160 and a subset region of a set size (e.g., default size, pre-defined size, etc.) may be utilized. For instance, a subset region may be located based on the point (e.g., the subset region may be centered on the point, an upper-left corner of the subset region may be located at the point, etc.).

In some examples, a sensor(s) may be included in the hybrid structure display 160 and/or may be associated with the hybrid structure display 160. For instance, the hybrid structure display 160 may include a touch sensor (e.g., capacitive or resistive touch matrix). The touch sensor may detect user interaction (e.g., contact) with the hybrid structure display 160 to determine the subset region 166. In some examples, the user 168 may walk up to the hybrid structure display 160 and draw a rectangle on a region of the hybrid structure display 160.

Based on the region of the hybrid structure display 160 indicated by the user interaction, the hybrid structure display 160 may produce a segmented display based on the pixels associated with the user contact (e.g., pixels in a closed loop in front of the user 168). The channel of content 170 may include a separate display channel, and the hybrid structure display 160 may produce a picture-in-picture (PIP) in the subset region 166 with a second source different from a first source for the remainder of the hybrid structure display 160. For instance, by using touch to define the subset region 166, a PIP may be set up for the subset region 166 and the channel of content 170 (e.g., streaming content) may be automatically adjusted for the user's personal size rather than being constrained to certain zoom sizes and/or specific regions of the hybrid structure display 160.

In some examples, an image sensor(s) (e.g., camera(s)) may be utilized to identify the user 168 with facial recognition. For instance, the recognized face may be utilized as credentials to access the channel of content 170. For instance, a cloud source may be accessed using the recognized face to access flight information, a map(s), etc., with display options tailored to the user 168.

In some examples, the hybrid structure display 160 may scale (e.g., scale down) a copy of the content being displayed on the hybrid structure display 160 (e.g., on the whole hybrid structure display) to provide the channel of content 170. The scaled copy may be zoomable and/or scrollable to allow the user 168 to see the content with greater ease. For instance, the hybrid structure display 160 may present flight information. If the user 168 requested flight map information, a copy of the full display stream may be mapped as the channel of content 170 in the subset region 166 created based on dimensions indicated by the user 168.

In some examples, the user 168 may view the channel of content 170 and walk away when done. The user's absence may be detected. For instance, an image(s) from the image sensor(s) may be utilized to determine that the user's face is no longer in view. In some examples, the subset region 166 may be removed in response to the user's absence. For instance, the subset region 166 may be removed to be restored back to the general display stream. In some examples, the subset region 166 may be removed after a threshold period (e.g., 5 seconds, 10 seconds, 30 seconds, 1 minute, 2 minutes, 5 minutes, etc.). For instance, if a user is not detected for the threshold period and/or a user's absence is detected for the threshold period, the subset region 166 may be removed. In some examples, the subset region 166 may be removed in response to an input detected from the user 168. For instance, the user 168 may tap an interface element (e.g., button, word, symbol, etc.), make a touch pattern (e.g., swipe, slash, flick, etc.), make a gesture (e.g., grab and toss, head shake, etc.), etc. The channel of content 170 and/or the subset region 166 may be closed (e.g., dismissed) in response to the detected input (from sensor data, for instance).

In some cases, large format displays may be difficult for some users to view. For instance, if a user is near a large format display, it may be difficult to discern the entire image being presented. Moreover, some users with eye issues may have difficulty viewing content in some formats.

Some examples of the techniques described herein may provide personalized content for a user or users. For instance, a hybrid structure display 160 may automatically source screen content that is tailored to the user 168 based on context. Some examples of the techniques described herein may provide approaches to automatically personalize content based on user identification without a user specifying target content for a subset region. Some examples of the techniques described herein may allow a display (e.g., touch screen display) to be segmented into subset regions to privatize content for users (instead of showing content on a whole display, for instance).

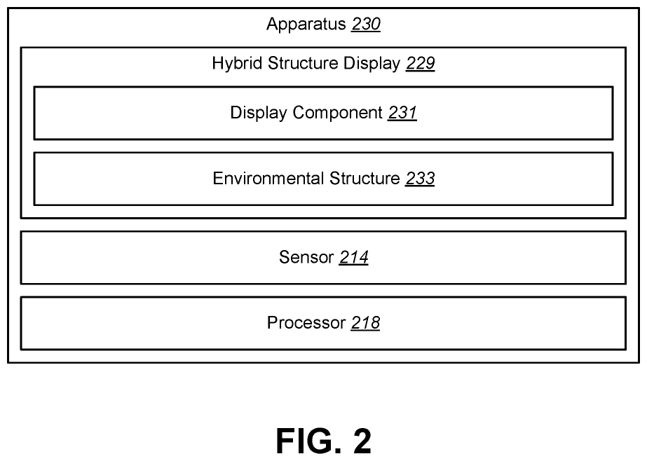

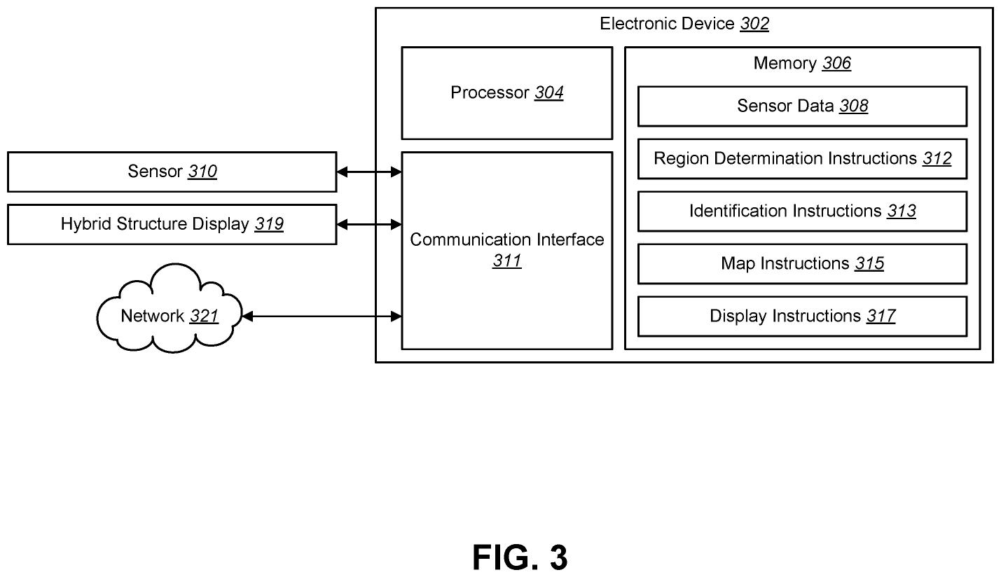

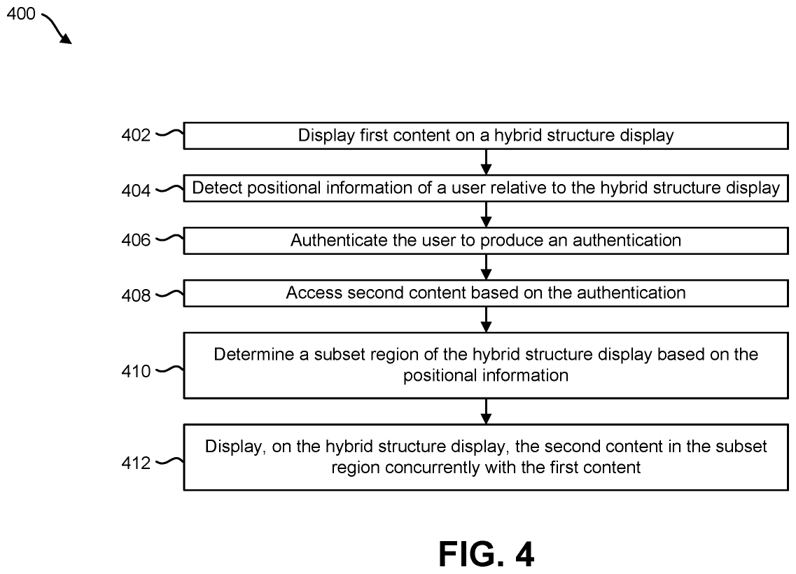

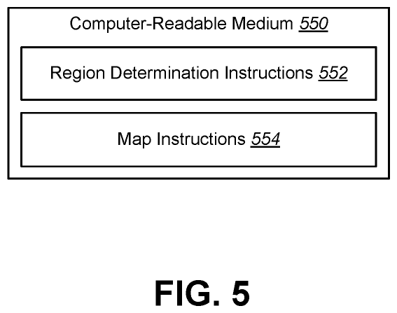

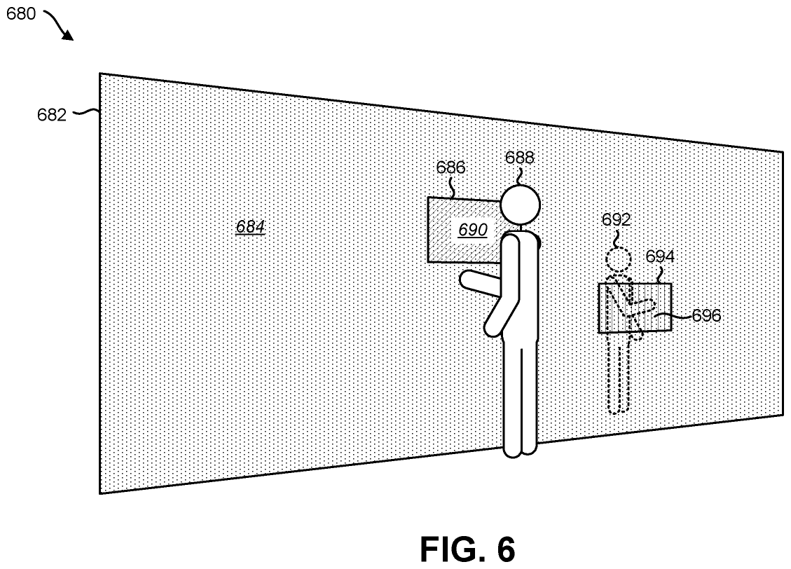

FIG. 2 is a block diagram illustrating an example of an apparatus 230 including a hybrid structure display 229. The hybrid structure display 160 described in relation to FIG. 1 may be an example of the hybrid structure display 229 described in relation to FIG. 2. In some examples, the apparatus 230 and/or a component(s) thereof may perform an aspect(s) and/or operation(s) described in FIG. 1, FIG. 3, FIG. 4, FIG. 5, FIG. 6, or a combination thereof. In some examples, the electronic device 302 described in relation to FIG. 3 may be included in the apparatus 230. In some examples, the apparatus 230 may include a hybrid structure display 229, a sensor 214, and/or a processor 218. In some examples, the apparatus 230 may include multiple hybrid structure displays 229, sensors 214, and/or processors 218. In some examples, the apparatus 230 may include a computing component(s), electronic device(s), computing device(s), mobile device(s), smartphone(s), etc. In some examples, one, some, or all of the components of the apparatus 230 may include hardware or circuitry.

The hybrid structure display 229 may include a display component 231 and an environmental structure 233. In some examples, the environmental structure 233 may be an architectural structure. For instance, the environmental structure 233 may be a wall, floor, ceiling, door, etc. For example, the environmental structure 233 may be a wall fabricated from glass, plastic, metal, wood, drywall, stone, brick, or a combination thereof. In some examples, the environmental structure 233 may be a transparent wall. In some examples, the environmental structure 233 may be attached to a floor and/or ceiling. For instance, the environmental structure 233 may span from a floor to a ceiling. In some examples, the environmental structure 233 may support a building structure (e.g., ceiling). In some examples, the hybrid structure display may include furniture. For instance, the environmental structure 233 may be furniture (e.g., a table, a desk, a chair, etc.).

The display component 231 may include a display panel (e.g., LED panel, OLED panel, etc.), a light array, digital sign, etc. In some examples, the display component 231 may be structurally integrated with the environmental structure 233. For instance, the hybrid structure display 229 may include a display panel attached to a transparent glass and/or plastic wall (e.g., sandwiched between glass and/or plastic sheets).

The apparatus 230 may include a sensor(s) 214. Examples of a sensor may include a contact sensor, touch sensor, capacitive matrix (e.g., contact-sensitive capacitive grid), resistive matrix (e.g., contact-sensitive resistive grid), pressure sensor, proximity sensor, temperature sensor, image sensor (e.g., time-of-flight (ToF) camera, optical camera, red-green-blue (RGB) sensor, web cam, millimeter wave sensor, infrared (IR) sensor, depth sensor, radar, etc., or a combination thereof), electrostatic field sensor (e.g., electrode(s)), microphone, microphone array, vibration sensor, etc. In some examples, the sensor 214 may include a sensor array and/or multiple sensors. In some examples, the sensor 214 may be included in (e.g., integrated into) the hybrid structure display 229. For instance, a contact sensor (e.g., capacitive grid) may correspond to (e.g., may be layered with) the display component 231 and/or the environmental structure 233 of the hybrid structure display 229. In some examples, electrodes to detect changes in an electrostatic field may be included in the hybrid structure display 229. In some examples, an image sensor(s) may be included in the hybrid structure display 229 or may be disposed separately from the hybrid structure display 229 (e.g., a camera(s) may be mounted to a ceiling above a digital sign, may be mounted with a field of view including the hybrid structure display 229, etc.).

In some examples, the sensor 214 may detect positional information corresponding to a user. Positional information is data indicating a spatial position. For instance, positional information may indicate a spatial position of a user relative to the hybrid structure display 229. The positional information may be detected and/or captured by a contact sensor, touch sensor, capacitive matrix, resistive matrix, pressure sensor, proximity sensor, temperature sensor, image sensor, electrostatic field sensor, microphone, microphone array, and/or vibration sensor, etc. In some examples, the positional information may be detected by a single type of sensor (e.g., contact sensor without an image sensor, an image sensor without a contact sensor, etc.) or may be detected by multiple types of sensors. In some examples, positional information may include contact sensor coordinates (e.g., x and y coordinates of a detected contact or touch). For instance, the sensor 214 may detect coordinates of a contact point corresponding to a user (e.g., a user's finger). In some examples, a contact point and/or touch pattern detected by the sensor 214 (e.g., contact sensor, touch sensor, etc.) may be positional information and/or positional information may be obtained from (e.g., calculated from, inferred from, etc.) a contact point and/or touch pattern.

In some examples, positional information may include image data from an image sensor(s). For instance, the positional information may be a frame of a video stream, where the frame depicts a user(s) in the field of view. For instance, the positional information may depict a first person and a second person. In some examples, positional information may include depth information, sound from a microphone array, vibration information from a vibration sensor array, electrostatic field variation, temperature data, etc.

The apparatus 230 may include a processor 218. The processor 218 is logic circuitry. For instance, the processor 218 may be a processor as similarly described in relation to FIG. 3. The processor 218 may determine a subset region of the hybrid structure display 229 based on the positional information. In some examples, the positional information (e.g., image(s)) may be provided to the processor 218 from the sensor 214. For instance, the processor 218 may utilize the positional information to determine a user position and/or to determine a subset region.

In some examples, the processor 218 may utilize the positional information (e.g., contact point) to determine the subset region. For instance, positional information from a contact sensor (e.g., touch sensor) may correspond to coordinates of the hybrid structure display 229 (e.g., pixel location(s)), which may be utilized to determine the subset region. In some examples, the processor 218 may determine the subset region relative to a contact point (e.g., coordinates). For instance, the processor 218 may calculate a subset region dimension(s) (e.g., height and width, corner coordinates, radius, etc.) and/or subset region location based on the contact point. In some examples, the processor 218 may determine a rectangular subset region (with default dimensions, for instance) centered at the contact point.

In some examples, the processor 218 may utilize a touch pattern of the positional information to determine the subset region. For instance, the positional information may indicate a touch pattern (e.g., touch and drag, touch line(s), swipe(s), tap(s), etc.) on the hybrid structure display 229. For instance, the touch pattern may indicate a shape (e.g., rectangle, circle, irregular shape, etc.). In some examples, the processor 218 may determine the subset region as an area within a closed shape (e.g., rectangle, circle, irregular closed shape, etc.) indicated by the touch pattern.

In some examples, the processor 218 may determine a size (e.g., dimensions, corner coordinates, etc.) of the subset region based on a size of the touch pattern. For instance, the processor 218 may determine the extrema of the touch pattern (e.g., pixel coordinates corresponding to the extrema of the touch pattern) in two dimensions (e.g., y0, y1, x0, x1) and may set boundaries of the subset region at the extrema (e.g., a “top” boundary at y0, a “bottom” boundary at y1, a “left” boundary at x0, and a “right” boundary at x1).

In some examples, the processor 218 may select a size and/or resolution of the subset region based on the touch pattern. For instance, the touch pattern may not precisely fit a size and/or resolution (e.g., discrete size and/or resolution). The processor 218 may select a size and/or resolution of the subset region (from a set of discrete sizes and/or resolutions, for instance) that is most proximate to that of a region indicated by the touch pattern.

In some examples, the processor 218 may utilize the positional information to determine a position corresponding to a user. The position corresponding to the user may be mapped to the hybrid structure display 229 and/or may be utilized to determine the subset region. For instance, the position (e.g., spatial location) may be mapped to a coordinate (e.g., nearest coordinate) of the hybrid structure display 229 (e.g., looked up) and/or a coordinate (e.g., nearest coordinate) of the hybrid structure display 229 to the user position may be calculated.

In some examples, the processor 218 may determine, based on an image(s), a position corresponding to a user. For instance, the processor 218 may execute a machine learning model to detect a person (e.g., face, head, body, etc.). Machine learning is a technique where a machine learning model (e.g., artificial neural network (ANN), convolutional neural network (CNN), etc.) is trained to perform a task based on a set of examples (e.g., data). Training a machine learning model may include determining weights corresponding to structures of the machine learning model. In some examples, artificial neural networks may be a kind of machine learning model that may be structured with nodes, layers, connections, or a combination thereof.

In some examples, a machine learning model may be trained with a set of training images. For instance, a set of training images may include images of an object(s) for detection (e.g., images of a user, people, etc.). In some examples, the set of training images may be labeled with the class of object(s), location (e.g., region, bounding box, etc.) of object(s) in the images, or a combination thereof. The machine learning model may be trained to detect the object(s) by iteratively adjusting weights of the model(s) and evaluating a loss function(s). The trained machine learning model may be executed to detect the object(s) (with a degree of probability, for instance). For example, the hybrid structure display 229 may be utilized with computer vision techniques to detect an object(s) (e.g., a user, people, etc.).

In some examples, an apparatus uses machine learning, a computer vision technique(s), or a combination thereof to detect a person or people. For instance, an apparatus may detect a location of a person (e.g., face) in an image and provide a region that includes (e.g., depicts) the person. For instance, the apparatus may produce a region (e.g., bounding box) around a detected face. The location and/or region may indicate the position corresponding to the user.

In some examples, the processor 218 may process sound from a microphone array to determine a direction of the received sound (e.g., voice, speed) from a user. The direction may be utilized to determine the position corresponding to the user, which may be mapped to a coordinate of the hybrid structure display 229. In some examples, the processor 218 may process vibration information from a vibration sensor array to determine a peak vibration (e.g., footstep, sound vibration) position corresponding to a user. The peak vibration position may be mapped to a coordinate of the hybrid structure display 229. In some examples, the processor 218 may process an electrostatic field signal from an electrode array to determine a position of an electrostatic field variation corresponding to a user. In some examples, the processor 218 may process temperature data from a temperature sensor and/or IR sensor to determine a position of heat corresponding to a user. In some examples, the processor 218 may utilize depth data (e.g., a depth map) from a depth sensor (e.g., ToF camera) to determine a position corresponding to a user (e.g., user distance to the hybrid structure display 229). The position corresponding to the user may be mapped to a coordinate of the hybrid structure display 229.

In some examples, the processor 218 may utilize the position corresponding to the user and/or the coordinate of the hybrid structure display 229 to determine the subset region. For instance, the processor 218 may calculate a subset region dimension(s) (e.g., height and width, corner coordinates, radius, etc.) and/or subset region location based on the position corresponding to the user and/or based on the coordinate. In some examples, the processor 218 may determine a rectangular subset region (with default dimensions, for instance) centered at the coordinate.

In some examples, the processor 218 may utilize the position corresponding to the user and/or the coordinate to determine a size (e.g., dimensions, corner coordinates, etc.) of the subset region. For instance, the size may be determined in accordance with a mapping (e.g., function, lookup table, etc.) based on a distance between the position corresponding to the user. For instance, a smaller distance may correspond to a smaller subset region size and/or a larger distance may correspond to a larger subset region size.

In some examples, the subset region may be located based on the position corresponding to the user. For instance, the subset region may be centered at the coordinate mapped from the position corresponding to the user. In some examples, the subset region may be determined to be located at an eye level of the user or offset from an eye level (e.g., a distance above or below eye level).

In some examples, the processor 218 may cause the hybrid structure display 229 to display a channel of content in the subset region. Examples of a channel of content may include streaming video, productivity content (e.g., email, word processing, etc.), Internet content (e.g., website content), video game content, informational content (e.g., flight times, train arrival/departure times, flight gates, directory information, map(s), etc.), etc. In some examples, the processor 218 may cause the hybrid structure display 229 to display a scaled version of the general content being displayed on the hybrid structure display 229 as described in relation to FIG. 1. In some examples, the processor 218 may format the channel of content. For instance, the processor 218 may scale the content, crop the content, shift the content, interpolate the content, transform the content, and/or place the content in a scrollable format, etc. In some examples, the processor 218 may utilize sensor data (e.g., input(s), tap(s), gesture(s), speech, etc.) to select and/or control the channel of content.

In some examples, the processor 218 may map the channel of content based on identification information. In some examples, the sensor 214 may provide sensor data (e.g., image(s), fingerprint reader information, biometric scanner, etc.) that indicates the identification information. For instance, the processor 218 may perform facial recognition to recognize a user. In some examples, the processor 218 may determine a facial feature(s) (e.g., distances between facial features, facial image, etc.) that may be utilized to recognize a user identity from a database (e.g., cloud database). For instance, the identification information may be utilized to search a database for a profile with a matching facial feature(s), where the profile may indicate the identity of the user. In some examples, the processor 218 may utilize other biometric information (e.g., fingerprint, corneal scan, voice, etc.) to look up an identity of the user. In some examples, the apparatus 230 may receive identification data (e.g., username, password, etc.) via the sensor 214. For instance, the hybrid structure display 229 may present a virtual keyboard in the subset region to receive identification data from the user (by typing the identification data, for instance). In some examples, the apparatus 230 may send the image(s), other biometric information, and/or identification data to a networked device (e.g., server), which may look up the user identity and send the user identity to the apparatus 230.

In some examples, the processor 218 may utilize the identification information to perform an authentication. For instance, the processor 218 may utilize the user identity to determine whether the user is authorized to access content (e.g., secured content, privileged content, etc.). For instance, the user identity may be associated with a permission(s) (e.g., permission(s) in a database) indicating that the user is authorized to access content (e.g., a channel(s) of content). In some examples, the apparatus 230 may send the identification information to an authentication server, which may determine whether the identification information satisfies an authentication condition. The authentication server may send an indication to the apparatus 230 and/or processor 218 indicating whether the user is authenticated based on the identification information. In some examples, the processor 218 may access the channel of content based on the authentication. For instance, the apparatus 230 and/or processor 218 may request and/or receive the channel of content based on the authentication. For instance, the apparatus 230 may access secure content (e.g., paid content, email, ticket information, receipt information, banking information, etc.) based on the authentication.

In some examples, a source of the channel content may be a mobile device carried by the user. For instance, a mobile device (e.g., smartphone, laptop, tablet device, etc.) may send the channel content (e.g., screen mirror, stream, etc.) to the apparatus 230. In some examples, the mobile device may be screenless.

FIG. 3 is a block diagram illustrating an example of an electronic device 302 that may be used to operate a hybrid structure display 319. An electronic device may be a device that includes electronic circuitry. Examples of the electronic device 302 may include a computer (e.g., laptop computer), a smartphone, a tablet computer, mobile device, camera, etc. In some examples, the electronic device 302 may include or may be coupled to a processor 304, memory 306, or a combination thereof. In some examples, components of the electronic device 302 may be coupled via an interface(s) (e.g., bus(es), wire(s), connector(s), etc.). The electronic device 302 may include additional components (not shown) or some of the components described herein may be removed or modified.

In some examples, the electronic device 302 may include a communication interface(s) 311. The electronic device 302 may utilize the communication interface(s) 311 to communicate with an external device(s) (e.g., networked device, server, smartphone, microphone, camera, computer, keyboard, mouse, etc.). In some examples, the electronic device 302 may be in communication with (e.g., coupled to, have a communication link with) a hybrid structure display 319. The hybrid structure display 319 may be an example of a hybrid structure display as described herein. In some examples, the electronic device 302 may include (or may be coupled to) an input device such as a touchscreen, keyboard, mouse, or a combination thereof.

In some examples, the communication interface 311 may include hardware, machine-readable instructions, or a combination thereof to enable a component (e.g., processor 304, memory 306, etc.) of the electronic device 302 to communicate with the external device(s). In some examples, the communication interface 311 may enable a wired connection, wireless connection, or a combination thereof to the external device(s). In some examples, the communication interface 311 may include a network interface card, may include hardware, may include machine-readable instructions, or may include a combination thereof to enable the electronic device 302 to communicate with an input device(s), an output device(s), or a combination thereof. Examples of output devices include a hybrid structure display 319. Examples of input devices include a sensor(s) 310, a keyboard, a mouse, a touchscreen, image sensor, microphone, etc. In some examples, a user may input instructions or data into the electronic device 302 using an input device(s). In some examples, the communication interface(s) (e.g., Mobile Industry Processor Interface® (MIPI®), Universal Serial Bus (USB) interface, etc.) may be coupled to the processor 304, to the memory 306, or a combination thereof.

In some examples, the communication interface(s) 311 may be in communication with a sensor(s) 310. The communication interface(s) 311 may receive sensor data 308 from the sensor(s) 310. For instance, the sensor data 308 may include video from an image sensor. The communication interface(s) 311 may provide sensor data 308 to the processor 304 and/or the memory 306 from the sensor(s) 310.

The sensor 310 may be a device to sense or capture sensor data 308 (e.g., an image stream, video stream, contact information, depth information, sound information, vibration information, etc.). Some examples of the sensor(s) 310 may include a contact sensor (e.g., touch sensor), optical (e.g., visible spectrum) image sensor, red-green-blue (RGB) sensor, IR sensor, depth sensor, vibration sensor, etc., or a combination thereof. In some examples, the sensor(s) 310 may be similar to the sensor(s) 214 described in relation to FIG. 2.

In some examples, the communication interface(s) 311 may be in communication with a network(s) 321. In some examples, the communication interface(s) 311 may communicate with the sensor(s) 310 and/or hybrid structure display 319 via the network(s) 321 and/or separately from the network(s) 321. Examples of the network(s) 321 may include a local area network(s) (LAN(s)), wide area network(s) (WAN(s)), the Internet, etc. In some examples, the communication interface(s) 311 may communicate with a remote device(s) (not shown in FIG. 3) (e.g., identification server(s), authentication server(s), content source(s), etc.) via the network(s) 321.

In some examples, the memory 306 may be an electronic storage device, magnetic storage device, optical storage device, other physical storage device, or a combination thereof that contains or stores electronic information (e.g., instructions, data, or a combination thereof). In some examples, the memory 306 may be, for example, Random Access Memory (RAM), Electrically Erasable Programmable Read-Only Memory (EEPROM), a storage device, an optical disc, the like, or a combination thereof. In some examples, the memory 306 may be volatile or non-volatile memory, such as Dynamic Random Access Memory (DRAM), EEPROM, magnetoresistive random-access memory (MRAM), phase change RAM (PCRAM), memristor, flash memory, the like, or a combination thereof. In some examples, the memory 306 may be a non-transitory tangible machine-readable or computer-readable storage medium, where the term “non-transitory” does not encompass transitory propagating signals. In some examples, the memory 306 may include multiple devices (e.g., a RAM card and a solid-state drive (SSD)). In some examples, the memory 306 may be integrated into the processor 304. In some examples, the memory 306 may include (e.g., store) a sensor data 308, region determination instructions 312, identification instructions 313, map instructions 315, display instructions 317, or a combination thereof.

The processor 304 is logic circuitry. Some examples of the processor 304 may include a general-purpose processor, central processing unit (CPU), a graphics processing unit (GPU), a semiconductor-based microprocessor, field-programmable gate array (FPGA), an application-specific integrated circuit (ASIC), other hardware device, or a combination thereof suitable for retrieval and execution of instructions stored in the memory 306. In some examples, the processor 304 may be an application processor. In some examples, the processor 304 may perform one, some, or all of the aspects, operations, elements, etc., described in one, some, or all of FIG. 1-6. For instance, the processor 304 may perform an operation(s) described in relation to the processor 218 described in relation to FIG. 2. In some examples, the processor 304 may include electronic circuitry that includes electronic components for performing an operation or operations described herein without the memory 306. In some examples, the processor 304 may perform one, some, or all of the aspects, operations, elements, etc., described in one, some, or all of FIG. 1-6.

In some examples, the processor 304 may receive sensor data 308 (e.g., image sensor stream, video stream, etc.). For instance, the processor 304 may receive an image stream via a wired or wireless communication interface 311 (e.g., MIPI, USB port, Ethernet port, Bluetooth receiver, etc.).

In some examples, the processor 304 may execute the region determination instructions 312 to determine, based on the sensor data 308, a position corresponding to a user. For example, the processor 304 may execute the region determination instructions 312 to determine the position corresponding to the user as described in relation to FIG. 2.

In some examples, the processor 304 may execute the region determination instructions 312 to determine, based on the position, a subset region of a hybrid structure display 319. For example, the processor 304 may execute the region determination instructions 312 to determine a subset region as described in relation to FIG. 1 and/or FIG. 2.

In some examples, the processor 304 may execute the identification instructions 313 to identify the user. For instance, the processor 304 may execute the identification instructions 313 to identify the user as described in relation to FIG. 2. In some examples, the processor 304 may execute the identification instructions 313 to authenticate the user as described in relation to FIG. 2.

In some examples, the processor 304 may execute the map instructions 315 to map a channel of content to the subset region based on the identification. For instance, the processor 304 may access the channel of content based on the identification (and/or authentication). In some examples, the processor 304 may map the channel of content to a subset region corresponding to a user with the identification. For instance, multiple users may utilize the hybrid structure display 319 concurrently in some examples. The processor 304 may associate a subset region and/or channel of content with an identified user. The processor 304 may map the channel of content to a subset region corresponding to an identified user. In some examples, the electronic device 302 (e.g., processor 304) may determine channel content based on the identification. For instance, the electronic device 302 may look up target content for a user associated with the user's identification and/or may map channel content corresponding to an earlier session (e.g., previously closed subset region and/or channel) conducted with the identified user. In some examples, the processor 304 may utilize the sensor data 308 to spatially track the user relative to the hybrid structure display 319, which may enable the processor 304 to move a subset region according to user movements (e.g., if a user sits down, walks along the hybrid structure display 319, etc.).

In some examples, the processor 304 may execute the display instructions 317 to cause the hybrid structure display 319 to display the channel of content in the subset region. In some examples, the electronic device 302 may cause the hybrid structure display 319 to display the channel of content as described in relation to FIG. 1 and/or FIG. 2. For instance, the electronic device 302 (e.g., communication interface 311) may send the channel of content to the subset region (e.g., pixel address range, PIP, etc.) of the hybrid structure display 319. In some examples, the electronic device 302 may retrieve the channel of content from a remote device(s) (e.g., content source(s)) via the network(s) 321 and/or from memory 306.

FIG. 4 is a flow diagram illustrating an example of a method 400 for displaying content of a hybrid structure display. In some examples, the method 400 or a method 400 element(s) may be performed by an electronic device, apparatus, and/or hybrid structure display (e.g., apparatus 230, electronic device 302, hybrid structure display 160, hybrid structure display 229, hybrid structure display 319, etc.). For example, the method 400 may be performed by the apparatus 230 described in relation to FIG. 2. In some examples, an aspect(s) of the method 400 may be performed by the electronic device 302 described in relation to FIG. 3.

An apparatus may display 402 first content on a hybrid structure display. In some examples, the first content is general content. For instance, the first content may be displayed over an entire hybrid structure display (e.g., over the entire display component except for in a subset region(s) or over the entire display component concurrently with a subset region(s) with a semi-transparent effect, for instance). In some examples, the apparatus may display the first content as described in one, some, or all of FIGS. 1-3. In some examples, the first content may be public and/or non-secure content.

The apparatus may detect 404 positional information of a user relative to the hybrid structure display. In some examples, detecting 404 the positional information may be performed as described in relation to FIG. 2 and/or FIG. 3. For instance, detecting 404 the positional information may include detecting a touch pattern, on the hybrid structure display, indicating a closed shape.

The apparatus may authenticate 406 the user to produce an authentication. In some examples, authenticating 406 the user may be performed as described in relation to FIG. 2 and/or FIG. 3.

The apparatus may access 408 second content based on the authentication. The second content may be personalized content, targeted content, and/or secure content. In some examples, accessing 408 the second content may be performed as described in relation to FIG. 2 and/or FIG. 3. For instance, the apparatus may access the second content from a storage device and/or from a remote device (e.g., source device, server, etc.) in response to a successful authentication. In some examples, the apparatus may submit authentication information to a source device to access the second content.

The apparatus may determine 410 a subset region of the hybrid structure display based on the positional information. In some examples, determining 410 the subset region may be performed as described in relation to FIG. 1, FIG. 2, and/or FIG. 3. For instance, determining 410 the subset region may include determining a size of the subset region based on the touch pattern.

The apparatus may display 412, on the hybrid structure display, the second content in the subset region concurrently with the first content. In some examples, displaying 412 the second content may be performed as described in relation to FIG. 1, FIG. 2, and/or FIG. 3. For instance, the second content may be displayed in the subset region while the first content is being displayed over the rest of the display component. In some examples, an aspect(s) and/or operation(s) of the method 400 may be omitted and/or combined.

FIG. 5 is a block diagram illustrating an example of a computer-readable medium 550 for controlling a hybrid structure display. The computer-readable medium 550 is a non-transitory, tangible computer-readable medium. In some examples, the computer-readable medium 550 may be, for example, RAM, DRAM, EEPROM, MRAM, PCRAM, a storage device, an optical disc, the like, or a combination thereof. In some examples, the computer-readable medium 550 may be volatile memory, non-volatile memory, or a combination thereof. In some examples, the memory 306 described in FIG. 3 may be an example of the computer-readable medium 550 described in FIG. 5.

The computer-readable medium 550 may include data (e.g., information, executable instructions, or a combination thereof). In some examples, the computer-readable medium 550 may include region determination instructions 552 and/or map instructions 554.

The region determination instructions 552 may include instructions when executed cause a processor of an electronic device to determine a subset region of a hybrid structure display. In some examples, determining a subset region may be performed as described in one, some, or all of FIG. 1-4.

The map instructions 554 may include instructions when executed cause the processor to map a channel of content to the subset region. In some examples, mapping a channel of content may be performed as described in one, some, or all of FIG. 1-4. For instance, the processor may scale, shift, transform, crop, format, etc., the channel of content to a size (e.g., pixel dimensions) and/or a location (e.g., pixel range) of the subset region. In some examples, the computer-readable medium 550 may include instructions to perform one, some, or all of the operations described in relation to one, some, or all of FIGS. 1-4 and/or FIG. 6.

FIG. 6 is a diagram illustrating an example of a hybrid structure display 680 with a first subset region 686 and a second subset region 694. The hybrid structure display 680 may be an example of the hybrid structure display 160 described in relation to FIG. 1, the hybrid structure display 229 described in relation to FIG. 2, and/or the hybrid structure display 319 described in relation to FIG. 3, etc. The hybrid structure display 680 may include an environmental structure 682 and a display component 684. In the example of FIG. 6, the hybrid structure display 680 is a transparent wall display.

In some examples of the techniques described herein, a hybrid structure display may produce multiple personalized subset regions corresponding to respective users. For instance, an aspect(s) and/or technique(s) described herein may be performed for multiple users. In the example of FIG. 6, the hybrid structure display 680 may display a first subset region 686 corresponding to a first user 688 and a second subset region 694 corresponding to a second user 692. For instance, an apparatus (e.g., apparatus 230) and/or an electronic device (e.g., electronic device 302) may utilize a sensor(s) to detect first positional information of the first user 688 and second positional information of the second user 692.

The first positional information and the second positional information may be utilized to determine the first subset region 686 and the second subset region 694, respectively. The apparatus (e.g., apparatus 230) and/or electronic device (e.g., electronic device 302) may map a first channel of content 690 to the first subset region 686 and a second channel of content 696 to the second subset region 694. In some examples, the apparatus and/or electronic device may identify and/or authenticate the first user 688 and the second user 692 to map the first channel of content 690 and the second channel of content 696. In some examples, the identification and/or authentication may be utilized to move a subset region with a user, to reopen a previously closed session corresponding to a user, etc.

In some examples, a mapping may be based on a side of a hybrid structure display where a user is located. For instance, the first channel of content 690 may be mapped in an order (e.g., from left to right or from a lower pixel index to a higher pixel index for the first user 688 on a front side) and the second channel of content 696 may be mapped in a reverse order (e.g., from right to left or from a higher pixel index to a lower pixel index for the second user 692 on a back side). In some examples, sensor data may be utilized to determine the side where a user is positioned. For instance, image sensors may capture images from different sides. Positional information from the image sensors may indicate an orientation (e.g., pixel mapping order, rotation, etc.) of the mapping. Another sensor(s) may be utilized to determine a side(s). For instance, sensor data from a depth sensor(s), from a microphone array, and/or from a temperature sensor(s), etc., may be utilized to determine a side. In another example where a hybrid structure display is a tabletop with different edges or a circular edge, sensor data (e.g., positional information) may be utilized to determine an orientation(s) of a subset region(s) and/or a mapping(s) of a channel(s) of content (to orient each channel towards a respective user, for instance).

The first subset region 686 may be utilized to display a first channel of content 690 (e.g., first personalized content) corresponding to the first user 688 and a second channel of content 696 (e.g., second personalized content) corresponding to the second user 692.

As used herein, the term “and/or” may mean an item or items. For example, the phrase “A, B, and/or C” may mean any of: A (without B and C), B (without A and C), C (without A and B), A and B (but not C), B and C (but not A), A and C (but not B), or all of A, B, and C.

As used herein, items described with the term “or a combination thereof” may mean an item or items. For example, the phrase “A, B, C, or a combination thereof” may mean any of: A (without B and C), B (without A and C), C (without A and B), A and B (without C), B and C (without A), A and C (without B), or all of A, B, and C.

While various examples are described herein, the described techniques are not limited to the examples. Variations of the examples are within the scope of the disclosure. For example, operation(s), aspect(s), or element(s) of the examples described herein may be omitted or combined.

1. An apparatus, comprising:
a hybrid structure display comprising a display component and an environmental structure to display a first channel of content;
a sensor to detect positional information corresponding to a user; and
a processor to:
determine a subset region of the hybrid structure display based on the positional information; and
cause the hybrid structure display to display a second channel of content as a picture-in-picture in the subset region.

2. The apparatus of claim 1, wherein the sensor is a touch sensor.

3. The apparatus of claim 1, wherein the positional information is obtained from a touch pattern on the hybrid structure display.

4. The apparatus of claim 3, wherein the processor is to determine a size of the subset region based on a size of the touch pattern.

5. The apparatus of claim 1, wherein the environmental structure is an architectural structure.

6. The apparatus of claim 5, wherein the architectural structure is a wall.

7. The apparatus of claim 1, wherein the processor is to map the channel of content based on identification information.

8. The apparatus of claim 7, wherein the processor is to:
utilize the identification information to perform an authentication; and
access the channel of content based on the authentication.

9. The apparatus of claim 1, wherein a source of the channel of content is a mobile device carried by the user.

10. An electronic device, comprising:
a communication interface to receive sensor data from a sensor; and
a processor to:
determine, based on the sensor data, a position corresponding to a user;
determine, based on the position, a subset region of a hybrid structure display;
cause the hybrid structure display to display a first channel of content;
map a second channel of content to the subset region; and
cause the hybrid structure display to display the second channel of content as a picture-in-picture in the subset region.

11. The electronic device of claim 10, wherein the hybrid structure display comprises furniture.

12. The electronic device of claim 10, wherein the sensor data comprises video from an image sensor.

13. The electronic device of claim 10, wherein the processor is to:
identify the user based on the sensor data to produce an identification; and
map the channel of content to the subset region based on the identification.

14. A method, comprising:
displaying first content on a hybrid structure display;
detecting positional information of a user relative to the hybrid structure display;
determining a subset region of the hybrid structure display based on the positional information; and
displaying, on the hybrid structure display, second content as a picture-in-picture in the subset region concurrently with the first content.

15. The method of claim 14, wherein detecting the positional information comprises detecting a touch pattern, on the hybrid structure display, indicating a closed shape.

16. The method of claim 15, wherein determining the subset region comprises determining a size of the subset region based on the touch pattern.

17. The method of claim 14, further comprising:
authenticating the user to produce an authentication; and
accessing the second content based on the authentication.

18. The apparatus of claim 1, wherein the hybrid structure display includes content on a front side and a rear side of the environmental structure.

19. The apparatus of claim 1, wherein the processor determines a size of the subset region based on a distance between the user and the hybrid structure display.

20. The apparatus of claim 19, wherein a smaller distance corresponds to a smaller size for the subset region.
